(19) United States
(12) Patent Application Publication
(10) Pub. No.: US 2020/0034692 A1
(43) Pub. Date: Jan. 30, 2020

(54) MACHINE LEARNING SYSTEM AND METHOD FOR COPING WITH POTENTIAL OUTLIERS AND PERFECT LEARNING IN CONCEPT-DRIFTING ENVIRONMENT

(71) Applicant: National Chengchi University, Taipei City (TW)

(72) Inventor: Rua-Huan Tsaih, Taipei City (TW)

(73) Assignee: National Chengchi University, Taipei City (TW)

(21) Appl. No.: 16/278,626

(22) Filed: Feb. 18, 2019

Related U.S. Application Data
(60) Provisional application No. 62/711,672, filed on Jul. 30, 2018.

(51) Int. Cl. G06N 3/04; G06N 3/08

(52) U.S. Cl. CPC G06N 3/0454; G06N 3/0481; G06N 3/08; G06N 3/0472

(57) ABSTRACT

The present disclosure provides methods and systems for coping with outliers and perfect learning in a concept-drifting environment. Data in the concept-drifting environment are time series data, and embodiments of the present disclosure uses moving windows to solve the problem of concept-drifting.

### CROSS-REFERENCE TO RELATED APPLICATION

This application relates to and claims the benefit of U.S. Provisional Application No. 62/711,672, filed Jul. 30, 2018, the entirety of which is incorporated herein by reference.

### BACKGROUND OF THE INVENTION

### 1. Field of the Invention

The present invention pertains generally to data processing; more particularly to processing data in a concept-drifting environment.

### 2. Description of Related Art

The term “concept drifting” means the concepts are not stable and changing with time. That is, as the time passes, the trend embedded in the observation data usually changes. For instance, in the early years of gold market, there are only financial professionals involved in the gold investment. Later, there are also Chinese Dama rushed to purchase gold as an investment. As could be appreciated, in the near future, there will be not only the financial professionals and the Chinese Dama, but also intelligent robot-advisory systems involved in the gold trading. The mix of different knowledge bases, objectives and tools makes the operation concept of gold market drift.

A basic challenge faced by data mining and machine learning techniques is to model and capture the time-evolving trends and patterns of these time-series data so as to make good predictions. Therefore, and ideal model for processing time-series data shall have the capability to modify its knowledge or concepts based on new data. To do so, one must cope with the following four concepts: concept drifting, outlier detection, machine learning, and perfect learning.

Many scholars have proposed an incremental learning approach to cope with the time-changing environment; such incremental learning techniques could not only learn new concepts but also retain existing concepts that are still relevant in the training model. The incremental learning is implemented through the sequence-based moving window to handle the data expiration problem. As time passes, older time series data should no longer be learned and newer incoming time series data should be taken into consideration. This approach has several weak points; for example, the high volume of data in a short period renders it a costly task, and models trained from the window may not be optimal for a larger window may still contain the concept drifts, whereas a smaller window may result in over-fitting.

Outlier detection also plays a key role. Fitting the observation data containing outliers could decrease the effectiveness of the resulted fitting function because outliers have a great effect on model estimation with their high fitting deviances. For instance, it is known that the side effect of outliers would diminish the forecast accuracy in time-series data. For example, Jussi Tolvi considered outliers' side effect while predicting monthly stock market index returns via ARMA model, and the result shows that the data sets without outliers, distinguished by autoregressive, get better predictions (see, Tolvi, J. (2002). Outliers and predictability in monthly stock market index returns. Finnish Journal of Business Economics, 6(4), 369-380). Thus, outlier detection is a critical process in data cleansing and the step of data cleansing is very important before modelling the data.

A variety of outlier detections has been designed to identify the observations which deviate considerably from most of data and then purify the data. For instance, the peer group analysis (PGA) has been used to cope with fraud detection in financial time series data. PGA is an unsupervised technique that identifies peer groups for all the target objects, and it concentrates more on local patterns than global models. Some tried to use k-means clustering method to detect outliers in software measurement data, where the value k is decided by cubic clustering. Others presented a technique for detecting outliers in multi-dimensional streams, which adapted to new incoming data points while incrementally maintained the built model. Another outlier detection technique is based on a novel continuously adaptive probability density function that addresses all the new issues of data streams.

In the artificial neural networks field, the single-hidden layer feed-forward neural network (SLFN) is very popular and a robust learning algorithm tunes the network's weights and thresholds, but does not alter the number of hidden nodes. However, there are often tens to hundreds of hidden layers, which means thousands hidden nodes, and hence billions of parameters of the hidden nodes, in the SLFN. Moreover, the numbers of hidden layers and hidden nodes are determined based on the rule of thumb, and a great deal of trial and error shall be performed to obtain a better learning efficacy. As a consequence, it is difficult to obtain an optimal function with the SLFN.

Tsaih and Cheng proposed a resistant learning (RL) mechanism with SLFN and a tiny pre-specified ε value (10⁻⁶) to deduce a function form (see, R. H. Tsaih and T. C. Cheng (2009), A resistant learning procedure for coping with outliers, Annals of Mathematics and Artificial Intelligence, vol. 57, no. 2, pp. 161-180). The RL dynamically adapts the number of adopted hidden nodes and the associated weights of the SLFN during the training process. They also implemented both robustness analysis and deletion diagnostics to exclude potential outliers at the early stage, thereby preventing the SLFN from learning them. The idea of robustness analysis contains features for deriving an (initial) subset of m+1 observations to fit the linear regression model, ordering the residuals of all N observations at each stage and then augmenting the reference subset gradually, based upon the smallest trimmed sum of the squared residuals principle. The deletion diagnostics employs with the diagnostic quantity being the number of pruned hidden nodes when one observation is excluded from the reference pool.

Above all, the weight-tuning mechanism, the recruiting mechanism, and the reasoning mechanism are implemented to allow the SLFN to evolve dynamically during the learning process and to explore an acceptable nonlinear relationship between explanatory variables and the responses in the presence of outliers.

Currently, there is no effective approach to identify outliers in a concept-drifting environment. Accordingly, it is advantageous to provide a method capable of coping with outliers and then perfect learning in a concept-drifting environment.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In a first aspect, the present disclosure is directed to a computer-implemented method for coping with outliers and perfect learning in a concept-drifting environment having a plurality of time series data. The present method is based on universal approximation theorem and adopts a weight-and-structure-change learning algorithm so that the hidden layer may dynamically increase or reduce the hidden nodes according to the learning condition during the iterative training process. Thus, the present method may learn training data in any format, and give an optimal function for the model.

According to certain embodiments of the present disclosure, the computer-implemented method comprises the following steps, (a) from a time-series data set having a plurality of observations, dividing the plurality of observations into moving windows, wherein each moving window comprises N training observations and D testing observations, and each moving window is shifted by B observations as compared with the previous moving window; (b) learning the training observations of the M^{th} moving window and identifying N*k % outlier candidates in M^{th} moving window, thereby obtaining an initial SLFN, wherein k % is a pre-determined percent of potential outliers; (c) discarding the N*k % outlier candidates identified in the step (b), and applying the initial SLFN to learn the remaining N*(1−k %) non-outlier training observations of the M^{th} moving window, thereby obtaining a revised SLFN; (d) testing the revised SLFN with remaining N*(1−k %) non-outlier training observations and the next D testing observations of the M^{th} moving window; and (e) reiterating the steps (b) and (d) for the M+1^{th} moving window.

According to some optional embodiments, the step (b) is performed with the resistant learning algorithm with envelope module (RLEM).

According to some optional embodiments, the step (c) is performed with the alternative RLEM.

In some embodiments, the half envelope width for use in the step (b) is 2a, whereas the half envelope width for use in the step (c) is 0.01σ.

According to some embodiments, there are m variables for the input of each training reference observation in the M^{th} moving window, and the step (b) comprises the steps of, (b-1) using the first m+1 training observations in the M^{th} moving window to establish a first SLFN having only one hidden node, and n=m+2, n is the number of the training observations that have been learned; (b-2) determining whether n>N*(1−k %), and if n>N*(1−k %), then the step (b) stops, thereby obtaining the initial SLFN; and if not, then the following steps is performed until the initial SLFN is obtained; (b-3) calculating a squared residual of each of the N training observations in the M^{th} moving window and a standard deviation (σ) of the squared residual of all the N training observations in the M^{th} moving window; and (b-4) arranging the N training observations with their respective squared residual value in ascending order and determining whether the squared residual value of the n^{th} training reference observation is less than the first half envelope width ε, wherein ε is a pre-determined value, and (b-4-1) if the squared residual value of the n^{th} training reference observation is less than the first half envelope width, a pruning mechanism is performed to remove all irrelevant hidden nodes, n+1 is set as n and the method returns to the step (b-2); and (b-4-2) if not, setting \tilde{w}=w, where w is the weights of the first SLFN and w is the stored weights, and applying a gradient descent mechanism to adjust the w until one of the following conditions is met: (i) the envelope contains at least n training observations and the method returns to step (b-4-1), or (ii) setting w=\tilde{w} and applying an augmenting mechanism to add extra two hidden nodes, thereby obtaining the initial SLFN. In some optional embodiments, the first half envelope width is 2σ.

According to some embodiments of the present disclosure, the step (c) further comprises the steps of, (c-1) setting R=1; (c-2) determining whether R>N*(1−k %), and if R>N*(1−k %), then the step (c) stops, thereby obtaining the revised SLFN; and if not, then the following steps is performed until the revised SLFN is obtained; (c-3) calculating a squared residual of each of the remaining N*(1−k %) non-outlier training observations in the M^{th} moving window and a standard deviation (σ) of the squared residual of all the N training observations in the M^{th} moving window; and (c-4) arranging the N*(1−k %) training observations with their respective squared residual value in ascending order and determining whether the squared residual value of the R^{th} training reference observation is less than the second half envelope width ε, wherein ε is a pre-determined value, and (c-4-1) if the squared residual value of the R^{th} training reference observation is less than the second half envelope width, a pruning mechanism is performed to remove all irrelevant hidden nodes, R+1 is set as R and the method returns to the step (c-2); and (c-4-2) if not, setting \tilde{w}=w and applying a gradient descent mechanism to adjust the w until one of the following conditions is met: (i) the envelope contains at least R training reference observation and the method returns to step (c-4-1), or (ii) setting w=\tilde{w} and applying an augmenting mechanism to add extra hidden nodes, thereby obtaining the revised SLFN. In some optional embodiments, the second half envelope width is 0.01σ.

In a second aspect, the present disclosure is directed to a machine learning system for coping with outliers and perfect learning in a concept-drifting environment having a plurality of time series data.

According to some illustrative embodiments, the machine learning system comprises at least one storage device for embodying data and/or program code in a machine usable form; and at least one processor for performing operations in conjunction with the storage device, the operations being in accordance with the methods of the first aspect of the present disclosure.

### BRIEF DESCRIPTION OF THE DRAWINGS

The present description will be better understood from the following detailed description read in light of the accompanying drawings briefly discussed below.

FIG. 1 is a schematic diagram illustrating the implementation of a moving window;

FIG. 2 is a flow diagram illustrating the computer-implemented method for coping with outliers and perfect learning in a concept-drifting environment, according to some embodiments of the present disclosure.

FIG. 3 is a flow diagram illustrating the computer-implemented method for coping with outliers in a concept-drifting environment, according to optional embodiments of the present disclosure.

FIG. 4 is a flow diagram illustrating the computer-implemented method for perfect learning, according to optional embodiments of the present disclosure.

FIG. 5 is a diagram showing the 95th simulation set according to the working example of the present disclosure.

FIG. 6 is a diagram showing the 24th simulation set according to the working example of the present disclosure.

### DETAILED DESCRIPTION OF THE INVENTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

For convenience, certain terms employed in the specification, examples and appended claims are collected here. Unless otherwise defined herein, scientific and technical terminologies employed in the present disclosure shall have the meanings that are commonly understood and used by one of ordinary skill in the art.

Unless otherwise required by context, it will be understood that singular terms shall include plural forms of the same and plural terms shall include the singular. Specifically, as used herein and in the claims, the singular forms “a” and “an” include the plural reference unless the context clearly indicated otherwise. Also, as used herein and in the claims, the terms “at least one” and “one or more” have the same meaning and include one, two, three, or more. Furthermore, the phrases “at least one of A, B, and C”, “at least one of A, B, or C” and “at least one of A, B and/or C,” as use throughout this specification and the appended claims, are intended to cover A alone, B alone, C alone, A and B together, B and C together, A and C together, as well as A, B, and C together.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

The present disclosure provides a machine learning mechanism that is capable of identifying potential outliers in data (e.g., data related to business applications) from a concept-drifting environment, thereby preventing the decrease in accuracy caused by the inclusion of outliers by the algorithm.

For example, fintech innovation is one of the most noticeable trends in recent years. Due to the rapid development of fintech, more and more financial services start to use data analysis of time series data, machine learning mechanism to gain insight into customers' behavior patterns, conduct credit evaluation, make business decisions or further conduct risk management. However, in recent years, the social and business environments are concept drifting environments with outliers in such business data. Outliers may affect the data analysis or the conclusion inferred by the machine learning algorithm. The machine learning mechanism according to embodiments of the present disclosure can identify the outliers in concept drifting business data rapidly; a better business decision may be made by first identifying the outliers in the business data and ruling out these outliers, followed by data analysis and machine learning.

The present method can be applied in various industries. For example, in the business sector, one may extract keywords from the social media or business news, and then analyze and predict the trends in foreign currency exchange rates. In one embodiment, the prediction achieves a high accuracy rate of 56.7%. Moreover, the present method may be used to predict the income of interest rate spread transactions, and the data of exchange rates of various currencies, London Interbank Offered Rate (LIBOR), consumer price index (CPI), money supply, gross domestic product (GDP), etc. are used as input of the algorithm, which also achieves a good effect in the prediction of interest rate spread transactions. The present method is also applicable in evaluation of real estates. These applications may bring tremendous value to the business and financial sectors. The present invention is quite different from the traditional statistical methods in the field of finance. The present method is a great development in the field of neural networks, which will benefit machine learning and finance at the same time in the future.

Furthermore, the present method can be used to analyze the network traffic data, thereby arriving at rules for detecting the normal and aberrant network traffic. By using the GPU to implement this method, the present method can effectively detect the malicious attack, and quickly establish a defense mechanism within an hour of the occurrence of a malicious attack. The invention can be applied to national defense security and establish a stable network protection.

Other fields of application include the medical field. By analyzing huge amount of medical information, the present method can find information that has been gone unnoticed but may be of great benefits to the medical system, caregivers, and patients.

In view of the foregoing, a first aspect of the present disclosure is directed to a method for identifying potential outliers in a concept-drifting environment. The present method is based on the second generation machine learning system TensorFlow from Google Brain, and supports multi-GPU operation, thereby reducing the time it required to achieve a business decision. The present method implements the RLEM in an artificial neural network, and adopts the incremental learning strategy, and further copes with the concept-drifting problems in the time-series data using the moving window.

One advantage of the present method lies in that the standard for identifying a certain percentage (say, 5%) of the potential outliers depending on whether the squared residual of the instance is greater than the envelop width of γ*λ*σ, where γ is a pre-determined value no less than 1, λ is the normal score for a selected percentile point of the normal distribution, and σ is the standard deviation of the squared residual of all the training observations in a moving window. In some cases, λ is 1.96, which is the 5 percentile point of the normal distribution, whereas the value of γ depends on the strictness that the users intends to impose on the identification of outliers; γ is a constant value equal to or greater than 1.0, where the greater the γ value the stricter the identification process.

As will be appreciated by one skilled in the art, aspects of the present invention may also be embodied as a system or computer program product. Accordingly, different aspects of the present invention may take the foam of an entirely hardware embodiment, an entirely software embodiment (including firmware, resident software, micro-code, etc.) or an embodiment combining software and hardware aspects that may all generally be referred to herein as a “circuit,” “module” or “system.”

Furthermore, some aspects of the present invention may take the form of a computer program product embodied in one or more computer readable medium(s) having computer readable program code embodied thereon. Any combination of one or more computer readable media may be utilized. For example, the computer readable medium may be a computer readable signal medium (e.g., an electronic, magnetic, optical, electromagnetic, infrared, or semiconductor system, apparatus, or device, or any suitable combination thereof) or a computer readable storage medium (such as, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination thereof). In the context of the present disclosure, a computer readable storage medium may be any tangible medium that can contain, or store a program for use by or in connection with an instruction execution system, apparatus, or device.

As could be appreciated, program code embodied on a computer readable medium may be transmitted using any appropriate medium or means, including but not limited to wireless, wireline, optical fiber cable, RF, etc., or any suitable combination of the foregoing. Computer program code for carrying out operations according to the above-mentioned aspect/embodiments of the present invention may be written in any combination of one or more programming languages. The program code may execute entirely on one user's computer, partly on the user's computer, as a stand-alone software package, partly on the user's computer and partly on a remote computer, or entirely on the remote computer or server. For example, the remote computer may be connected to the user's computer through any type of network, such as a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In a first aspect, the present disclosure is directed to a computer-implemented method for coping with outliers and perfect learning in a concept-drifting environment having a plurality of time series data.

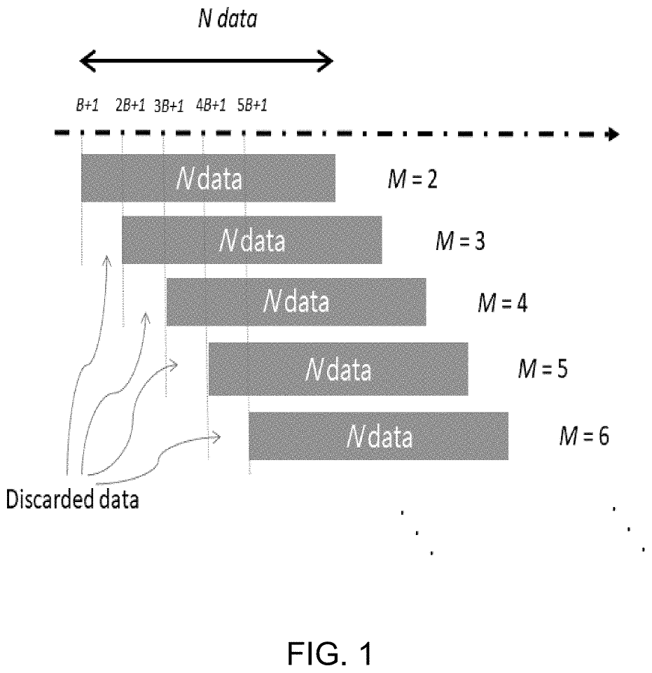

The present method uses the time-series data as the input. A moving window is used to prove the data points (i.e., observations) of the time-series data. FIG. 1 shows the arrangement of moving window while the time series data are sequential input in chronological order. In each window, there is a training block consisting of N training observation data, while each moving window is shifted by B observations as compared with the previous moving window. For instance, at the M^{th} window, the training block consists of {(x^{(M-1)*B+1}, y^{(M-1)*B+1}), (x^{(M-1)*B+2}, y^{(M-1)*B+2}), . . . , (x^{(M-1)*B+N}, y^{(M-1)*B+N})}. As time moves on, the window will slide to the M+1^{th} one whose training block consisting of {(x^{M*B+1}, y^{M*B+1}), (x^{M-*B+2}, y^{M*B+2}), . . . , (x^{M*B+N}, y^{M*B+N})} such that the instances of {(x^{(M-1)*B+1}, y^{(M-1)*B+1}), (x^{(M-1)*B+2}, y^{(M-1)*B+2}) . . . , (x^{M*B}y^{M*B})} are discarded. The guidelines of the parameter of N and B depend on the data nature.

Fitting the observation data containing outliers could decrease the effectiveness of the resulted fitting function because that outliers have a large influence on model estimation with their high fitting deviances. A variety of outlier detections has been designed to identify the observations which deviate considerably from most of data and then purify the data. It is important yet difficult to detect the outlier in the concept-drifting environment, involving outlier detection and concept drifts. Usually, these two can be quite difficult to be separated, considering they both include samples that do not follow the existing data distribution.

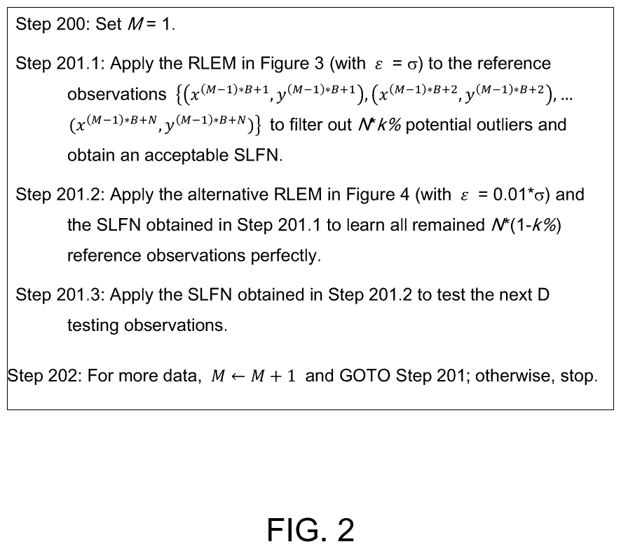

Reference is made to the flow chart in FIG. 2. In this embodiment, there is one training block in each window; M is the index of current window; N is the size of reference observations in the training block; B is the size of discarded reference observations. Also, σ is the standard deviation of the residual of all N reference observations.

According to some embodiments of the present disclosure, the method starts at the step 200, where M of the first window is set as 1.

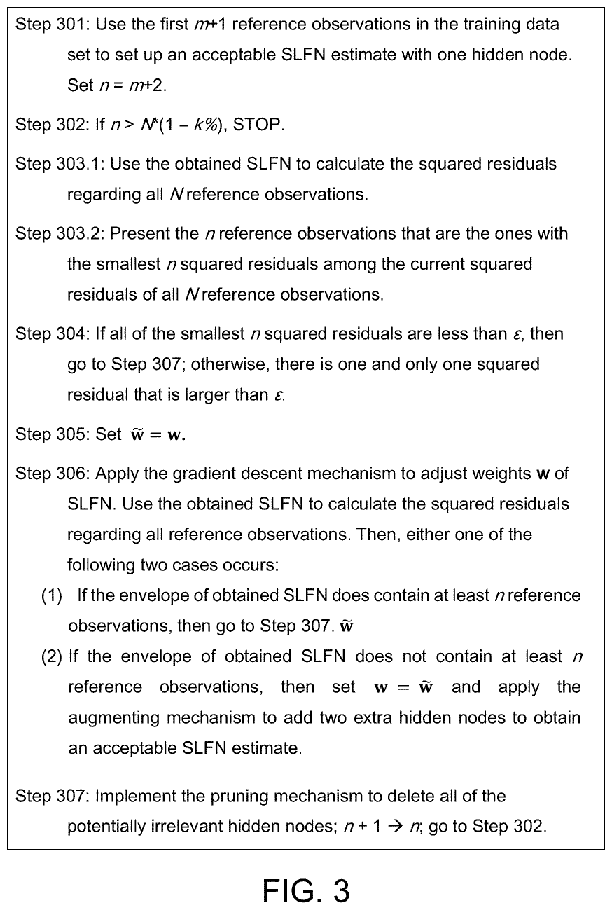

Then in step 201.1, the RLEM is applied to the reference observations. Specifically, we use N training data of the current window to obtain an acceptable SLFN via the RLEM according to FIG. 3 (discussed below). This step will let the SLFN to learn a fitting function ƒ wrapped with an envelope and the obtained fitting function, a non-linear function. Furthermore, we also get the training block's result, including order information and deviance information. Here, the “order information” is the order of learning sequence by SLFN in the n−1 stage, where n is minimized and n>N*(1−k %). We sure that n−1 data will be wrapped into the envelope.

Then, the last N*k % data, potential outlier, will be examined their deviance information. The “deviance information” is the distance between the fitting function ƒ and explanatory variable individually. Thus we can examine the last N*k % data which may not be wrapped into the envelope. If the potential outlier's deviation is larger than the acceptable threshold, ε, we will output this potential outlier as outlier candidate to decision maker.

Briefly, the decision support mechanism (DSM) will examine the potential outlier's deviation information to determine whether output it as outlier candidate or not. If the potential outlier's deviation information shows that the deviation is larger than c, the DSM will output this potential outlier as an outlier candidate to decision maker.

With the above material, the envelope will wrap the non-outliers into the envelope scope. In contrast, if the residual is bigger than the c, it will be lay out of envelope. Besides, it will be treated as the outlier candidate no matter which block it belongs. In the end, the DSM will report this outlier candidate to the decision maker.

As discussed above, at step 201.1 of FIG. 2, the RLEM is applied. FIG. 3 is a flowchart illustrating an example of the RLEM.

In step 301, we use the first m+1 reference observations to set up an acceptable SLFN. Then set n=m+2.

In step 302, there is a stopping criterion. In this example, where k % can be referred to the percentage of potential outlier. Clearly, at least (1−k %) data will be wrapped into the envelope. For example, if there are approximately at least 95% non-outliers and at most 5% outliers, the SLFN will take 95% data into consideration while building the SLFN.

In step 303, we try to calculate the squared residuals and determine the input sequence of reference observations in this stage. Furthermore, the input sequence is determined by the residual between the observations with the current SLFN which has already learned n−1 data. The squared residuals will be calculated in every stage, and the input sequence of reference observations will changed according to the squared residuals.

The modeling procedure implemented by Step 306 and Step 307 that adjusts the number of hidden nodes adopted in the SLFN estimate and the associated w to evolve the fitting function ƒ and its envelope to contain at least n observations at the nth stage. That is, at the nth stage, Step 303 presents the n reference observations that are the observations with the smallest n squared residuals among the current N squared residuals and are used to evolve the fitting function. Step 303 adopts the concept of forward selection, ordering the residuals of all N observations and then augmenting the reference subset gradually by including extra observations one by one to determine the input sequence of the reference observations. With this, some of the reference observations at the early stages might not stay in the set of reference observations at the later stages, although most of them will.

The modeling procedure implemented by Step 306 to Step 307 requires proper values of w and p so that the obtained envelope contains at least n observations at the end of the nth stage. Specifically, at the beginning of Step 6, the gradient descent mechanism is applied to adjust the weights w. In the step 306 (2) restores the \tilde{w} is stored in Step 305. Thus, we return to the previous SLFN estimate, and then the augmenting mechanism recruit two extra hidden nodes to obtain an acceptable SLFN estimate. In order to decrease the complexity of the fitting function ƒ, the reasoning mechanism is proposed in Step 307 to delete potentially irrelevant hidden nodes.

The RLEM results in a fitting function with an envelope that includes almost the majority of training data, and the outliers are expected to be included at later stages. We name the instances in this stage as potential outliers.

Then, we use the deviance information as the extra information to define whether the potential outliers are need to be the regarded as outlier candidates. Specifically, here we adopt both the deviance information and the order information to identify the potential outliers.

Regarding the order information for identifying the outliers, we treat the last k % data as potential outliers. Namely, if n≥N*(1−k %) AND the residual is greater than ε, and then this data is recorded as the outlier candidate. The setting of the ε value depends on the user's perception of the data and its associated outliers. For example, the perceptions are that the error is normally distributed, with a mean of 0 and a variance of 1, and the outliers are the points that have residuals that are greater than 1.96 (when the absolute value is taken). These perceptions are similar to the setting in the regression analysis that corresponds to a 5% significance level. Given that the error terms follow the normal distribution. Then, the user can set the ε value of the proposed envelope module to 1.96 and define the outliers as the points that have residuals that are greater than 1.96.

In sum, at the end of Step 201.1 of FIG. 2, RLEM stated in FIG. 3 will wrap N*(1−k %) reference observations with the least residuals among N instances and make N*k % reference observations with the bigger residuals become the outlier candidates.

The envelope width of the RLEM stated in FIG. 3 is 2ε. In contrast to a tiny ε value (10⁻⁶) proposed in RL, the proposed E value of RLEM is larger, says 0.05. The parameter kin Step 201 refers to the percentage of potential outlier, which means at least (1−k %) reference observations will be wrapped into the envelope. For example, assume we suspect that there are approximately at least 95 percent non-outliers and at most 5 percent outliers, then we can set k as 5% and the RLEM will result in a fitting function with an envelope that contains 95 percent reference observations into consideration while building the acceptable SLFN estimate. A SLFN estimate is acceptable at the n^{th} stage if all of the smallest n squared residuals are less than the pre-specified ε.

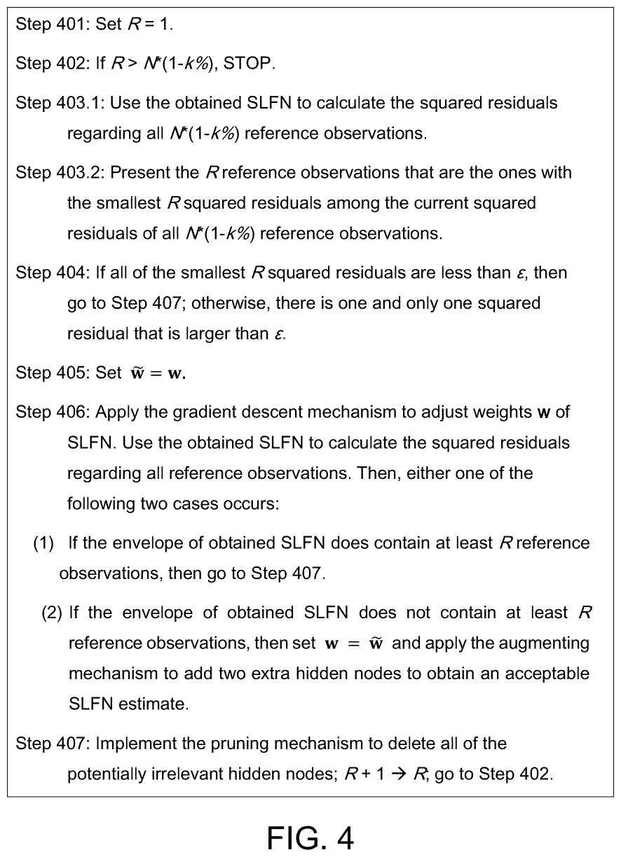

Moreover, in Step 201.2 of FIG. 2, the alternative RLEM according to FIG. 4 will render |e^{c}| values of all N*(1−k %) reference observations less than ε. For perfect learning, ε is modified to be smaller, said 0.01 g.

According to FIG. 4, the method starts at Step 401, in which n is set as 1.

Then, in Step 402, the stop criterion is similar to that of step 302.

Nest, in Step 403.1, we use the obtained SLFN to calculate the squared residuals regarding all N*(1−k %) reference observations, whereas in Step 403.2, we present the n reference observations that are the ones with the smallest n squared residuals among the current squared residuals of all N*(1−k %) reference observations.

The Steps 404 to 407 is similar to Steps 304 to 307, except that the ε here is much smaller.

As could be appreciated, to speed up the learning, the proposed method is implemented using TensorFlow and GPU. TensorFlow will take computations expressed as TensorFlow graphs and then map them onto a wide variety of different hardware platforms, ranging from running inference on mobile device platforms such as Android and iOS to modest-sized training and inference systems using single machines containing one or many GPU cards to large-scale training systems running on hundreds of specialized machines with thousands of GPUs. Having a single system that can span such a broad range of platforms significantly simplifies the real-world use of machine learning system.

In another aspect, the present disclosure is also directed to a machine learning system for coping with outliers and perfect learning in a concept-drifting environment having a plurality of time series data. According to various embodiments, the system comprises, at least one storage device for embodying data and/or program code in a machine usable form; and at least one processor for performing, in conjunction with the storage device, operations according to embodiments of the present disclosure.

The following Examples are provided to elucidate certain aspects of the present invention and to aid those of skilled in the art in practicing this invention. These Examples are in no way to be considered to limit the scope of the invention in any manner. Without further elaboration, it is believed that one skilled in the art can, based on the description herein, utilize the present invention to its fullest extent.

«Experiment Design»

The present disclosure makes a lot of effort to achieve decision support in dealing with outlier detection problem in concept drifting environment. Thus we take this experiment to justify this proposed mechanism and evaluate the result. In order to correspond to the proposed application environment, we try to build a concept drifting environment and the data is consisted of time series data. Then, the proposed mechanism will be applied to 100 simulation sets so as to evaluate the effectiveness of detecting outlier. For each simulation run, we use the geometric Brownian motion models stated in (1) to generate a former period of first 150 instances and a later period of next 50 instances, respectively. The 200 instances will be in chronological order, so it can be viewed as time series data. With 200 instances in each simulation set and total 100 simulation sets, we have gained total 20000 instances.

With a view to evaluating the performance of detecting outliers with this proposed mechanism in concept drifting environment, we make each simulation data contains at least 2 theoretical outliers while generating the experiment data. One in the first 150 instances set, and the other one is in the next 50 instances set. These 2 theoretical outliers belong to different concepts separately.

$$\begin{matrix}{X}_{t + 1} = {X}_{t} * exp ( 0.005 - \frac{{0.00001}^{2}}{2} + 0.00001 * {W}_{t} ) , 1 \leq t \leq 150 & ( 1 ) \\ {X}_{t + 1} = {X}_{t} * exp ( - 0.003 - \frac{{0.00003}^{2}}{2} + 0.00003 * {W}_{t} ) , 151 \leq t \leq 200 & ( 2 ) \\ {Y}_{t} = {X}_{t} + {ϵ}_{t} , t \geq 0 & ( 3 )\end{matrix}$$

First of all, we have to denote the initial value as X₀, and we set this value to 5. Wₜ, called Wiener random process, is the random noise generated by N(0,1), which means three things: (a) the distribution type is normal distribution, (b) the mean of the random noise will be close to 0, (c) last, the standard deviation will be near to 1.

As stated in equation (3), we add an error term ∈ₜ to Xₜ to get Yₜ. ∈ₜ has a normal distribution with the mean 0 and the standard deviation 2. In this simulation experiment, the reason we set the error term's standard deviation to 2 is based on the Xₜ's standard deviation almost near 1.4. In order to prevent the proposed mechanism from the similarity between non-outlier and outlier, we set the standard deviation to 2.

Due to the setting of 2.5 standard deviation, we have 2*2.5=5. That means 2.5 times of the error term's standard deviation. Based on the error term's standard deviation, we generate following rule for defining the theoretical outlier and theoretical non-outlier. If ∈ₜ<5, the sample is treated as theoretical non-outliers. If ∈ₜ≥5, the sample is treated as theoretical outliers. Based on this criterion, we gain total 281 theoretical outliers within total 20000 instances. Approximately 1.4%. Each simulation has at least 2 theoretical outliers belonging to different concepts separately. One in the first 150 instances and the other in the next 50 instances.

In order to set up a concept drifting environment, the parameter value is given in difference value in different period. We try to set the former period where 1≤t≤150, and Xₜ is generated by equation (1); thus the later period where 151≤t≤200, and Xₜ is generated by equation (2). It means that the concept is changed after t=151. The former period's trend seems to be rising with time. On the other hand, the volatility will become larger in later period. Note that we generated the data using python, version 2.7.

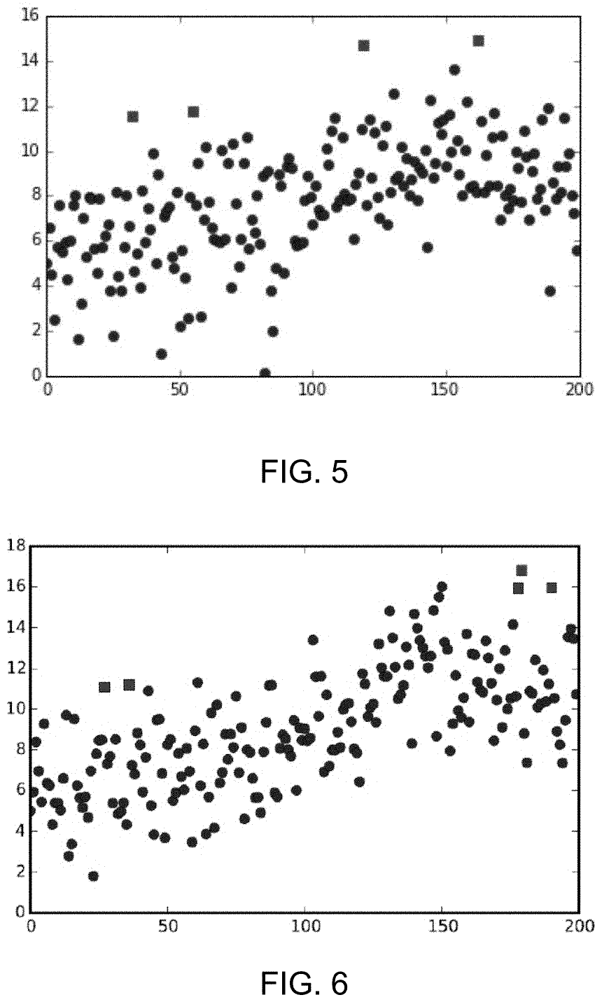

In FIG. 5, we take the 95th simulation set as an example. The x-axis is the time, displaying in chronological order, and the y-axis is the Y as the value of each instance. There are 2-colored instances in figure, and the color we display is according to the value ∈ₜ. The blue ones reflect their ∈ₜ do not exceed 5, as theoretical non-outliers. In contrast, the red ones obviously can be regarded as theoretical outliers, because the ∈ₜ have already equaled or exceeded 5. In this 95th simulation set, we have 4 theoretical outliers; 3 theoretical outliers in former period and 1 theoretical outlier in later period. The figure apparently shows the trend is rising where 1≤t≤150, and the later period's trend is dropping where 151≤t≤200. It's obvious that there is a trend change.

In this example, we design our experiment's sequence-based window slide 5 instances will be given in the sliding window sequentially, that is to say, we set B to 5. Here, we take the first window, where M=1, into consideration. The training block is consisted of 1^{st} to 100^{th} instances and the testing set is consisted of 101^{st} to 105^{th} instances. Then, the initial SLFN will be trained from the training block. Furthermore, with the RLEM (FIG. 3) elaboration, the envelope will wrap the least residual 95 instances, letting the bigger residual instances behind as potential outliers. Apparently, the least 95 residual instances learned by SLFN definitely view as non-outliers. We can tell whether other 5 potential outliers in training block is outlier candidate or not individually based on the order information and deviance information provided by the RLEM individually. The testing block's 5 instances, from 101^{st} to 105^{th}, are necessary to be tested by the SLFN obtained by the RELM. If the instance does not be wrapped in the envelope, we will output as outlier candidate. In contrast, if the instance can be wrapped in the envelope, this instance won't be output it as an outlier candidate.

As time goes, M=2. The first 5 instances, from 1^{st} to 5^{th}, will be discarded. The training block will slide to 6^{th}˜105^{th}. At the same time, the testing block also will slide to 106^{th}˜110^{th}, and so on until there is no incoming data.

Note that the concept has drifted after t=151. If the concept has drifted, some theoretical outliers located in the particular periods. Take the following 24^{th} simulation set as an example. In FIG. 6, we can see there are 5 theoretical outliers in this experiment set. It's obvious to see the concept has changed after t=151. Consider the proposed mechanism without incremental learning strategy, the theoretical outliers in former period may not be distinguished as outlier candidate with the aspect of building model using whole historical data. In FIG. 6, if without moving window, the 27^{th} and 36^{th} theoretical outliers may not be regarded as outlier candidate. So it is necessary to take the concept drifting environment into consideration. The moving window technique prevents the expired data from evolving the current model, letting the current model make a better distinction between non-outliers and outliers. So some theoretical outliers located in the former or later period may not be distinguished successfully as outlier candidates regarding the whole simulation data. We want to evaluate whether the changing environment affects the outlier detection via our proposed mechanism. During the process of sliding with moving window, we will record the output results. Then we will try to evaluate whether or not this mechanism performs well with concept drifting environment in each stage.

«Performance Evaluation»

Here we show a brief rule that how to evaluate the mechanism's performance in this study. According to the theoretical non-outlier or theoretical outlier defined when designing the experiment by judging ∈ₜ, we can compare the identification result to the proposed mechanism. There are four possible outcomes: (the term's first character is on behalf of the theoretical type and the second character is on behalf of the resulted type identified by the proposed mechanism)
(1) N-O: The theoretical non-outlier that has been incorrectly specified as outlier candidate.

(2) O-N: The theoretical outlier that has been incorrectly specified as non-outlier.

(3) O-O: The theoretical outlier that has been correctly specified as outlier candidate.

(4) N-N: The theoretical non-outlier that has been correctly specified as non-outlier.

There are two misrecognized identification types: Type I error, meaning theoretical non-outliers that has been incorrectly identified as outlier candidates; and Type II error, meaning theoretical outliers that has been incorrectly identified as non-outliers.

In the practical application, Type II is more critically serious than Type I. The main reason is Type II may be much more harmful than Type I to our decision or operation. In other words, the risks of Type II error may incur a greater loss to companies or organizations. Due to this reason, we hope that the proportion of Type II error can be very low.

Here we take the 95^{th} simulation set as an example. Table 1 is the result about take the 95^{th} simulation set. Furthermore, we also demonstrate the total 100 simulation sets' performance in Table 2 for discussion.

In the Table 1, we have learned that each window's accuracy is higher than 95% and even some windows' accuracy reach 100%. Here, we adopt indicators Type I and Type II to measure the experiment performance.

For the total 100 simulation sets' performance, we can know the total amount of theoretical outliers in the whole 100 simulation sets is 281. There are 275 theoretical outliers have been identified as outlier candidates—79 of them are detected within the training block (28.7%) and 196 within the testing block (71.3%). This is good phenomenon since the theoretical outliers can be detected as early as possible, especially in testing block. Note that some theoretical outliers are in the training block when M=1. So if this mechanism can be applied in long-term or infinite time series data. It's likely that we may get more theoretical outliers output as outlier candidate in the testing block.

In our study, we hope the proportion of Type II error can be less. Based on this anticipation, we have determined a rule: if the instance has been distinguished as outlier candidate whenever in each window, it will be output to decision maker in the first time. After outputting it to decision maker, decision maker have to evaluate whether it is a real outlier or not. Due to this mechanism, the decision maker only has to review the outlier candidates provided by this mechanism. With this rule, the decision maker needs to review only approximately 12% data. This mechanism decreases large proportion of data need to be reviewed and really achieves time-saving goal.

TABLE 1

| | | | Training block | | | | | | | | | |
|---|---|---|---|---|---|---|---|---|---|---|---|---|
| Time Stamp | | | Learning | | | | | | | | | |
| | Training | Testing | block | | Potential outier | | | | Testing block | | | |
| M | block | block | N—N | O—N | N—N | O—O | N—O | O—N | N—N | O—O | N—O | O—N |
| 1 | 1~100 | 101~105 | 95 | 0 | 1 | 2 | 2 | 0 | 5 | 0 | 0 | 0 |
| 2 | 6~105 | 106~110 | 95 | 0 | 2 | 2 | 1 | 0 | 4 | 0 | 1 | 0 |
| 3 | 11~110 | 111~115 | 95 | 0 | 2 | 2 | 1 | 0 | 4 | 0 | 1 | 0 |
| 4 | 16~115 | 116~120 | 95 | 0 | 1 | 2 | 2 | 0 | 3 | 1 | 1 | 0 |
| 5 | 21~120 | 121~125 | 95 | 0 | 0 | 3 | 2 | 0 | 4 | 0 | 1 | 0 |
| 6 | 26~125 | 126~130 | 94 | 1 | 1 | 2 | 2 | 0 | 5 | 0 | 0 | 0 |
| 7 | 31~130 | 131~135 | 95 | 0 | 1 | 3 | 1 | 0 | 5 | 0 | 0 | 0 |
| 8 | 36~135 | 136~140 | 94 | 1 | 1 | 1 | 3 | 0 | 5 | 0 | 0 | 0 |
| 9 | 41~140 | 141~145 | 94 | 1 | 0 | 1 | 4 | 0 | 5 | 0 | 0 | 0 |
| 10 | 46~145 | 146~150 | 94 | 1 | 1 | 1 | 3 | 0 | 5 | 0 | 0 | 0 |
| 11 | 51~150 | 151~155 | 95 | 0 | 2 | 1 | 1 | 1 | 5 | 0 | 0 | 0 |
| 12 | 56~155 | 156~160 | 95 | 0 | 1 | 2 | 2 | 0 | 5 | 0 | 0 | 0 |
| 13 | 61~160 | 161~165 | 95 | 0 | 0 | 1 | 4 | 0 | 4 | 1 | 0 | 0 |
| 14 | 66~165 | 166~170 | 95 | 0 | 2 | 2 | 1 | 0 | 5 | 0 | 0 | 0 |
| 15 | 71~170 | 171~175 | 95 | 0 | 1 | 2 | 2 | 0 | 5 | 0 | 0 | 0 |
| 16 | 76~175 | 176~180 | 95 | 0 | 2 | 2 | 1 | 0 | 5 | 0 | 0 | 0 |
| 17 | 81~180 | 181~185 | 95 | 0 | 3 | 2 | 0 | 0 | 5 | 0 | 0 | 0 |
| 18 | 86~185 | 186~190 | 95 | 0 | 3 | 2 | 0 | 0 | 5 | 0 | 0 | 0 |
| 19 | 91~190 | 191~195 | 95 | 0 | 3 | 2 | 0 | 0 | 5 | 0 | 0 | 0 |
| 20 | 96~195 | 196~200 | 95 | 0 | 2 | 2 | 1 | 0 | 5 | 0 | 0 | 0 |

| | | | Evaluation | | | |
|---|---|---|---|---|---|---|
| | | | | | | The |
| | | | | | | accumulated |
| Time Stamp | | | | | | amount of |
| | Training | Testing | | Type I | Type II | outlier |
| M | block | block | accuracy | error | error | candidates |
| 1 | 1~100 | 101~105 | 98% | 2% | 0% | 4 |
| 2 | 6~105 | 106~110 | 98% | 2% | 0% | 5 |
| 3 | 11~110 | 111~115 | 98% | 2% | 0% | 6 |
| 4 | 16~115 | 116~120 | 97% | 3% | 0% | 9 |
| 5 | 21~120 | 121~125 | 97% | 3% | 0% | 10 |
| 6 | 26~125 | 126~130 | 97% | 2% | 33% | 11 |
| 7 | 31~130 | 131~135 | 99% | 1% | 0% | 11 |
| 8 | 36~135 | 136~140 | 96% | 3% | 50% | 11 |
| 9 | 41~140 | 141~145 | 95% | 4% | 50% | 12 |
| 10 | 46~145 | 146~150 | 96% | 3% | 50% | 14 |
| 11 | 51~150 | 151~155 | 98% | 1% | 50% | 14 |
| 12 | 56~155 | 156~160 | 98% | 2% | 0% | 14 |
| 13 | 61~160 | 161~165 | 96% | 4% | 0% | 16 |
| 14 | 66~165 | 166~170 | 99% | 1% | 0% | 16 |
| 15 | 71~170 | 171~175 | 98% | 2% | 0% | 16 |
| 16 | 76~175 | 176~180 | 99% | 1% | 0% | 16 |
| 17 | 81~180 | 181~185 | 100% | 0% | 0% | 16 |
| 18 | 86~185 | 186~190 | 100% | 0% | 0% | 16 |
| 19 | 91~190 | 191~195 | 100% | 0% | 0% | 16 |
| 20 | 96~195 | 196~200 | 99% | 1% | 0% | 16 |

TABLE 2

| | The | | | | |
|---|---|---|---|---|---|
| | accumulated | Total | | | |
| | amount of | amount of | | | Total |
| Total 100 | outlier | theoretical | | Total amount | amount |
| simulation | candidates | outliers | Total amount of O—O | of O—N | of N—O |
| Total | 2408 | 281 | 275 | 6 | 2133 |
| 20000 | (12%) | (1.4%) | (275/281 ≈ 97.9%) | (6/281 ≈ 2.1%) | |
| instances | | | | | |

| Detected in | | | | | |
|---|---|---|---|---|---|
| which | Potential | Testing | Learning | Potential | Testing |
| block | outlier | block | block | outlier | block |
| | 196 | 79 | 2 | 1 | 3 |
| | (196/275 ≈ 71.3%) | (79/275 ≈ 28.7%) | | | |

In Table 2, there are 6 theoretical outliers that are not detected as outlier candidate, and this proportion is at approximately 2%. The total output amount of the outlier candidates is 2408, at around 12 percent. Same as experiment result about the theoretical outlier, this result explains a large proportion of outlier candidate being output while in the testing block. Furthermore, these 6 theoretical outliers that are not identified as outlier candidates are distributing in 6 individual simulation sets.

For investigating the reason causing Type II error, we investigate into each experiment result. Here we try to discuss possible reasons causing this error. Note that the misrecognized identification causes Type II error. Due to the characteristic of application area, we try to discuss some possible solutions to this error case. In the cases of 23^{rd}, 37^{th} and 75^{th} simulation sets (data not shown), the theoretical outliers are in the testing block of last window that consists of the 196^{th} to 200^{th} instances. Furthermore, the theoretical outlier is closer to the majority of the data.

It will be understood that the above description of embodiments is given by way of example only and that various modifications and combinations may be made by those with ordinary skill in the art. The above specification, examples, and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A computer-implemented method for coping with outliers and perfect learning in a concept-drifting environment having a plurality of time series data, comprising the steps of,
(a) from a time-series data set having a plurality of observations, dividing the plurality of observations into moving windows, wherein each moving window comprises N training observations and D testing observations, and each moving window is shifted by B observations as compared with the previous moving window;
(b) learning the training observations of the M^{th} moving window and identifying N*k % outlier candidates in M^{th} moving window, thereby obtaining an initial single-hidden layer feed-forward neural network (SLFN), wherein k % is a pre-determined percent of potential outliers;
(c) discarding the N*k % outlier candidates identified in the step (b), and applying the initial SLFN to learn the remaining N*(1−k %) non-outlier training observations of the M^{th} moving window, thereby obtaining a revised SLFN; and
(d) testing the revised SLFN with remaining N*(1−k %) non-outlier training observations and the D testing observations of the M^{th} moving window;
(e) reiterating the steps (b) and (d) for the M+1^{th} moving window.

2. The method according to claim 1, wherein the step (b) is performed with the RLEM shown in FIG. 3.

3. The method according to claim 2, wherein for the first moving window, there are m variables for the input of each training reference observation, and the step (b) comprises the steps of,
(b-1) using the first m+1 training observations in the first moving window to establish a first SLFN having only one hidden node, and n=m+2, n is the number of the training observations that have been learned;
(b-2) determining whether n>N*(1−k %), and
if n>N*(1−k %), then the step (b) stops, thereby obtaining the initial SLFN; and
if not, then the following steps is performed until the initial ANN is obtained;
(b-3) calculating a squared residual of each of the N training observations in the first moving window and a standard deviation (σ) of the squared residual of all the N training observations in the first moving window; and
(b-4) arranging the N training observations with their respective squared residual value in ascending order and determining whether the squared residual value of the n^{th} training reference observation is less than a first half envelope width ε, wherein ε is a pre-determined value, and
(b-4-1) if the squared residual value of the n^{th} training reference observation is less than the first half envelope width, a pruning mechanism is performed to remove all irrelevant hidden nodes, n+1 is set as n and the method returns to the step (b-2); and
(b-4-2) if not, setting \tilde{w}=w, where w is the weights of the first SLFN and \tilde{w} is the stored weights, and applying a gradient descent mechanism to adjust the w until one of the following conditions is met: (i) the envelope contains at least n training observations and the method returns to step (b-4-1), or (ii) setting w=\tilde{w} and applying an augmenting mechanism to add extra two hidden nodes, thereby obtaining the initial SLFN.

4. The method according to claim 3, wherein the first half envelope width is 2σ.

5. The method according to claim 1, wherein the step (c) is performed with the alternative RLEM shown in FIG. 4.

6. The method according to claim 5, wherein the step (c) further comprises the steps of,
(c-1) setting R=1;
(c-2) determining whether R>N*(1−k %), and
if R>N*(1−k %), then the step (c) stops, thereby obtaining the revised SLFN; and
if not, then the following steps is performed until the revised SLFN is obtained;
(c-3) calculating a squared residual of each of the remaining N*(1−k %) non-outlier training observations in the M^{th} moving window and a standard deviation (σ) of the squared residual of all the N training observations in the M^{th} moving window; and
(c-4) arranging the N*(1−k %) training observations with their respective squared residual value in ascending order and determining whether the squared residual value of the R^{th} training reference observation is less than a second half envelope width ε, wherein ε is a pre-determined value, and
(c-4-1) if the squared residual value of the R^{th} training reference observation is less than the second half envelope width, a pruning mechanism is performed to remove all irrelevant hidden nodes, R+1 is set as R and the method returns to the step (c-2); and
(c-4-2) if not, setting \tilde{w}=w, where \tilde{w} is the weights of the revised SLFN, and w is the weights of the initial SLFN, and applying a gradient descent mechanism to adjust the w until one of the following conditions is met: (i) the envelope contains at least R training reference observation and the method returns to step (c-4-1), or (ii) setting w=\tilde{w} and applying an augmenting mechanism to add extra hidden nodes, thereby obtaining the revised SLFN.

7. The method according to claim 6, wherein the second half envelope width is 0.01σ.

8. A machine learning system for coping with outliers and perfect learning in a concept-drifting environment having a plurality of time series data, comprising, at least one storage device for embodying data and/or program code in a machine usable form; and
at least one processor for performing operations in conjunction with the storage device, the operations comprising:
(a) from a time-series data set having a plurality of observations, dividing the plurality of observations into moving windows, wherein each moving window comprises N training observations and D testing observations, and each moving window is shifted by B observations as compared with the previous moving window;
(b) learning the training observations of the M^{th} moving window and identifying N*k % outlier candidates in M^{th} moving window, thereby obtaining an initial SLFN, wherein k % is a pre-determined percent of potential outliers;
(c) discarding the N*k % outlier candidates identified in the step (b), and applying the initial SLFN to the remaining N*(1−k %) non-outlier training observations of the M^{th} moving window, thereby obtaining a revised SLFN; and
(d) testing the revised SLFN with remaining N*(1−k %) non-outlier training observations and the D testing observations of the M^{th} moving window;
(e) reiterating the steps (b) and (d) for the M+1^{th} moving window, wherein the revised SLFN for the M^{th} moving window obtained in the step (c) is used as the initial SLFN to learn the training observations of the M+1^{th} moving window.

9. The machine learning system according to claim 8, wherein the step (b) is performed with the RLEM.

10. The machine learning system according to claim 9, wherein for the first moving window, there are m variables for the input of each training reference observation, and the step (b) comprises the steps of,
(b-1) using the first m+1 training observations in the first moving window to establish a first SLFN having only one hidden node, and n=m+2, n is the number of the training observations that have been learned;
(b-2) determining whether n>N*(1−k %), and
if n>N*(1−k %), then the step (b) stops, thereby obtaining the initial SLFN; and
if not, then the following steps is performed until the initial SLFN is obtained;
(b-3) calculating a squared residual of each of the N training observations in the first moving window and a standard deviation (σ) of the squared residual of all the N training observations in the first moving window; and
(b-4) arranging the N training observations with their respective squared residual value in ascending order and determining whether the squared residual value of the n^{th} training reference observation is less than a first half envelope width ε, wherein ε is a pre-determined value, and
(b-4-1) if the squared residual value of the n^{th} training reference observation is less than the first half envelope width, a pruning mechanism is performed to remove all irrelevant hidden nodes, n+1 is set as n and the method returns to the step (b-2); and
(b-4-2) if not, setting \tilde{w}=w, where \tilde{w} is the weights of the first SLFN and w is the stored weights, and applying a gradient descent mechanism to adjust the w until one of the following conditions is met: (i) the envelope contains at least n training observations and the method returns to step (b-4-1), or (ii) setting w=\tilde{w} and applying an augmenting mechanism to add extra two hidden nodes, thereby obtaining the initial SLFN.

11. The machine learning system according to claim 10, wherein the first half envelope width is 2σ.

12. The machine learning system according to claim 8, wherein the step (c) is performed with the alternative RLEM.

13. The machine learning system according to claim 12, wherein the step (c) further comprises the steps of,
(c-1) setting R=1;
(c-2) determining whether R>N*(1−k %), and
if R>N*(1−k %), then the step (c) stops, thereby obtaining the revised SLFN; and
if not, then the following steps is performed until the revised SLFN is obtained;
(c-3) calculating a squared residual of each of the remaining N*(1−k %) non-outlier training observations in the M^{th} moving window and a standard deviation (σ) of the squared residual of all the N training observations in the M^{th} moving window; and
(c-4) arranging the N*(1−k %) training observations with their respective squared residual value in ascending order and determining whether the squared residual value of the R^{th} training reference observation is less than a second half envelope width ε, wherein ε is a pre-determined value, and
(c-4-1) if the squared residual value of the R^{th} training reference observation is less than the second half envelope width, a pruning mechanism is performed to remove all irrelevant hidden nodes, R+1 is set as R and the method returns to the step (c-2); and
(c-4-2) if not, setting \tilde{w}=w, where \tilde{w} is the weights of the revised SLFN, and w is the weights of the initial SLFN, and applying a gradient descent mechanism to adjust the w until one of the following conditions is met: (i) the envelope contains at least R training reference observation and the method returns to step (c-4-1), or (ii) setting w=\tilde{w} and applying an augmenting mechanism to add extra hidden nodes, thereby obtaining the revised SLFN.

14. The machine learning system according to claim 13, wherein the second half envelope width is 0.01σ.
